(19) United States
(12) Patent Application Publication
(10) Pub. No.: US 2014/0175913 A1
(43) Pub. Date: Jun. 26, 2014

(54) SPINDLE MOTOR

(71) Applicant: SAMSUNG ELECTRO-MECHANICS CO., LTD, Suwon (KR)

(72) Inventors: Hong Joo LEE, Suwon (KR); Hyung Ki MOON, Suwon (KR); Ju Ho KIM, Suwon (KR); Hyun Ho SHIN, Suwon (KR)

(73) Assignee: SAMSUNG ELECTRO-MECHANICS CO., LTD, Suwon (KR)

(21) Appl. No.: 13/773,779

(22) Filed: Feb. 22, 2013

(30) Foreign Application Priority Data
Dec. 24, 2012 (KR) 10-2012-0152055

(51) Int. Cl. H02K 5/24

(52) U.S. Cl. CPC H02K 5/24
USPC 310/51

(57) ABSTRACT

A spindle motor includes a stator including a base member having a stator core installed thereon; and a rotor including a rotor hub in which a driving magnet facing the stator core is installed. The rotor hub includes a disk-shaped body, a magnet mounting part extended from edge of the body in a downward axial direction and having the driving magnet installed on an inner surface thereof, and a disk support part extended from the magnet mounting part in radial direction. A magnetic center of the driving magnet is higher than that of the stator core in the axial direction in order to generate force directed in the downward axial direction through interaction with the stator core. The magnet mounting part includes a vortex generation suppressing part disposed on a lower edge portion thereof to decrease noise and vibrations generated by flow of air during rotation of the rotor hub.

### CROSS-REFERENCE TO RELATED APPLICATIONS

This application claims the priority of Korean Patent Application No. 10-2012-0152055 filed on Dec. 24, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A hard disk drive (HDD), an information storage device, reads data stored on a disk or writes data to a disk using a read/write head.

A hard disk drive requires a disk driving device capable of driving a disk. In such a disk driving device, a small-sized spindle motor is used.

Meanwhile, the spindle motor according to the related art requires floating force for rotating a rotor. In this case, in order to prevent the rotor from being separated from a stator when an amount of floating force required for rotating the rotor, or more, is generated in the spindle motor and an external impact is applied to the spindle motor, a pulling plate has been disposed below a driving magnet to suppress floating force.

Alternatively, a pulling plate is omitted and a driving magnet is installed in a rotor hub such that a magnetic center of the driving magnet is disposed to be higher than that of a stator core in an axial direction to generate force in a downward axial direction, thereby preventing a rotor from being separated from a stator when an amount of floating force required for rotating the rotor, or more, is generated in the spindle motor and an external impact is applied to the spindle motor.

However, in the case in which the driving magnet is installed in the rotor hub so that the magnetic center thereof is disposed to be higher than that of the stator core in the axial direction, a predetermined space may be formed below the driving magnet, such that a vortex may be generated by flowing air.

Further, noise and/or vibrations are generated due to the generation of the vortex at the time of rotation of the rotor hub.

### RELATED ART DOCUMENT

### Patent Document

(Patent Document 1) Korean Patent Laid-Open Publication No. 2005-0077432

### SUMMARY OF THE INVENTION

An aspect of the present invention provides a spindle motor capable of decreasing noise and vibrations generated during rotation of a rotor hub.

According to an aspect of the present invention, there is provided a spindle motor including: a stator including a base member on which a stator core is fixedly installed; and a rotor including a rotor hub in which a driving magnet disposed to face the stator core is installed, wherein the rotor hub includes a body having a disk shape, a magnet mounting part extended from an edge of the body in a downward axial direction and having the driving magnet installed on an inner surface thereof, and a disk support part extended from the magnet mounting part in an outer radial direction, the driving magnet is installed on the magnet mounting part so that a magnetic center thereof is disposed to be higher than that of the stator core in the axial direction in order to generate force directed in the downward axial direction through interaction with the stator core, and the magnet mounting part includes a vortex generation suppressing part disposed on a lower edge portion thereof so as to decrease at least one of noise and vibrations generated by a flow of air during rotation of the rotor hub.

The vortex generation suppressing part may be formed of a vortex generation suppressing member installed on the lower edge portion of the magnet mounting part so as to be disposed below the driving magnet, the vortex generation suppressing member having a ring shape.

The vortex generation suppressing member may have the same width as that of the driving magnet in the radial direction and has a rectangular transversal cross section.

The vortex generation suppressing member may have an upper surface wider than a lower surface in the radial direction, such that it may have a trapezoidal transversal cross section.

The vortex generation suppressing member may be formed of a non-magnetic material.

A lower surface of the disk support part may be formed as an inclined surface inclined upwardly in the outer radial direction, an opposing surface of the base member opposed to the inclined surface of the disk support part may be disposed in parallel to the inclined surface, and a clearance formed between the vortex generation suppressing member and the base member and a clearance formed between the inclined surface and the opposing surface may have the same width.

A lower surface of the disk support part may be formed as an inclined surface inclined upwardly in the outer radial direction, an opposing surface of the base member opposed to the inclined surface of the disk support part may be disposed in parallel to the inclined surface, and the vortex generation suppressing part may be formed as a rounded surface forming a lower edge portion of an inner surface of the magnet mounting part.

The stator may include: the base member including an installation part on which the stator core is installed; a lower thrust member fixedly installed on an inner surface of the installation part; a shaft having a lower end portion fixedly installed on the lower thrust member; and an upper thrust member fixedly installed on an upper end portion of the shaft.

The rotor may include a sleeve forming, together with the lower thrust member, the shaft, and the upper thrust member, bearing clearances, and the rotor hub extended from the sleeve.

According to another aspect of the present invention, there is provided a spindle motor including: a base member having a stator core fixedly installed thereon; a sleeve fixedly installed on the base member; a shaft inserted into the sleeve and rotating; and a rotor hub fixedly installed on the shaft and including a body having a disk shape, a magnet mounting part extended from an edge of the body in a downward axial direction and having a driving magnet installed on an inner surface thereof, and a disk support part extended from the magnet mounting part in an outer radial direction, wherein the driving magnet is installed on the magnet mounting part so that a magnetic center thereof is disposed to be higher than that of the stator core in the axial direction in order to generate force directed in the downward axial direction through interaction with the stator core, and the magnet mounting part includes a vortex generation suppressing part disposed on a lower edge portion thereof so as to decrease at least one of noise and vibrations generated by a flow of air during rotation of the rotor hub.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of part A of FIG. 1;

FIG. 3 is an enlarged view showing a portion of a spindle motor corresponding to part A of FIG. 1 according to another embodiment of the present invention;

FIG. 4 is an enlarged view showing a portion of a spindle motor corresponding to part A of FIG. 1 according to another embodiment of the present invention;

FIG. 5 is a cross-sectional view schematically showing a spindle motor according to another embodiment of the present invention; and

FIG. 6 is an enlarged view showing part B of FIG. 5.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

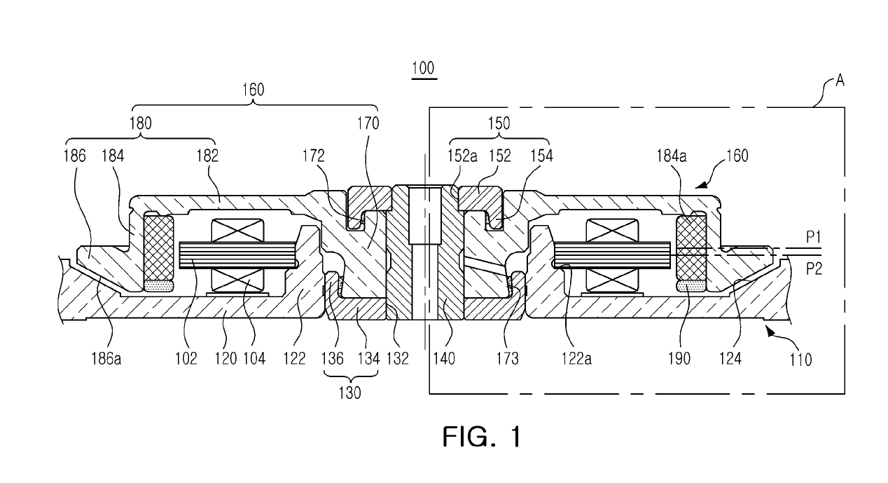

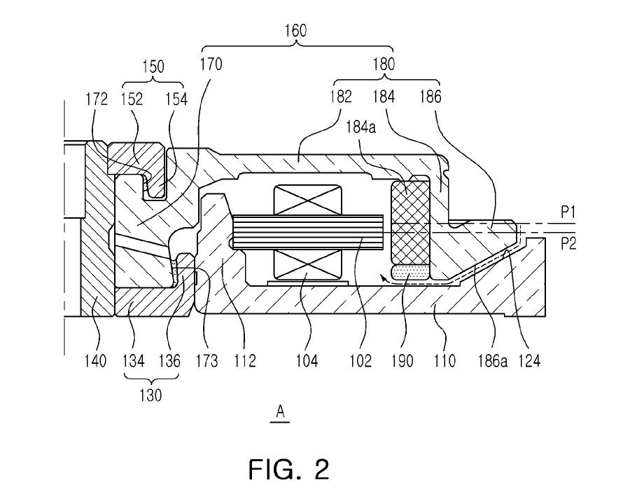

FIG. 1 is a cross-sectional view schematically showing a spindle motor according to an embodiment of the present invention; and FIG. 2 is an enlarged view showing part A of FIG. 1.

Referring to FIGS. 1 and 2, a spindle motor 100 according to the embodiment of the present invention may include a stator 110 and a rotor 160 by way of example.

Meanwhile, the stator 110, referring to all fixed members with the exception of a rotating member, may include a base member 120, a lower thrust member 130, a shaft 140, an upper thrust member 150, and the like.

In addition, the rotor 160 refers to a member rotating around the shaft 140 that is a rotating axis.

In addition, the spindle motor 100 according to the embodiment of the present invention may be a motor used in an information recording and reproducing device such as a hard disk drive, or the like.

Here, terms with respect to directions will be defined. As viewed in FIG. 1, an axial direction refers to a vertical direction, that is, a direction from a lower portion of the shaft 140 toward an upper portion thereof or a direction from the upper portion of the shaft 140 toward the lower portion thereof, and a radial direction refers to a horizontal direction, that is, a direction from the shaft 140 toward an outer peripheral surface of the rotor 160 or from the outer peripheral surface of the rotor 160 toward the shaft 140.

In addition, a circumferential direction refers to a rotation direction along an outer peripheral direction of the shaft 140 or the outer peripheral surface of the rotor 160.

The base member 120, a fixed member configuring the stator 110 as described above, may include an installation part 122 into which the lower thrust member 130 is inserted. The installation part 122 may be extended from the base member 120 in an upward axial direction and have a step surface 122a formed on an outer peripheral surface thereof so that a stator core 102 may be fixedly installed thereon.

Meanwhile, the base member 120 may have an opposing inclined surface 124 opposed to the rotor 160. A detailed description thereof will be provided below.

The lower thrust member 130, a fixed member configuring, together with the base member 120, the stator 110, may be fixedly installed on the base member 120.

In addition, the lower thrust member 130 may have a hollow cup shape. That is, the lower thrust member 130 may have an installation hole 132 formed therein so that a lower end portion of the shaft 140 may be inserted thereinto and fixed thereto.

In addition, the lower thrust member 130 may include a disk part 134 and an extension part 136 extended from an edge of the disk part 134 in the upward axial direction.

The shaft 140, a fixed member configuring the stator 110, may have the lower end portion fixedly installed on the lower thrust member 130 as described above. That is, the lower end portion of the shaft 140 may be inserted into the installation hole 132 formed in the disk part 134.

In addition, the shaft 140 may serve as a rotating axis of the rotor 160, and the rotor 160 may rotate around the shaft 140.

The upper thrust member 150, a fixed member configuring the stator 110, may be fixedly installed on an upper end portion of the shaft 140.

In addition, the upper thrust member 150 may have a shape similar to that of the lower thrust member 130. That is, the upper thrust member 150 may include a circular ring part 152 and an extension wall part 154 extended from the ring part 152 in a downward axial direction.

In addition, the circular ring part 152 may have a through-hole 152a formed therein so that the upper end portion of the shaft 140 is inserted thereinto.

The rotor 160 may include a rotor hub 180 in which a driving magnet 184a disposed to face the stator core 102 is installed. In addition, the rotor 160 may include a sleeve 170 forming, together with the lower thrust member 130, the shaft 140, and the upper thrust member 150, bearing clearances, and the rotor hub 180 extended from the sleeve 170.

Meanwhile, although the case in which the sleeve 170 and the rotor hub 180 are formed integrally with each other is described in the present embodiment, the present invention is not limited thereto. That is, the sleeve 170 and the rotor hub 180 may be manufactured as separate members and then coupled to each other.

The sleeve 170 may form, together with the lower thrust member 130, the shaft 140, and the upper thrust member 150, the bearing clearances as described above, and the bearing clearances may be filled with a lubricating fluid.

In addition, the spindle motor 100 according to the embodiment of the present invention may have a full-fill structure in which all of the above-mentioned bearing clearances are filled with the lubricating fluid.

Meanwhile, the sleeve 170 may have upper and lower inclined parts 172 and 173 formed on an outer peripheral surface thereof so as to form an interface between the lubricating fluid and air together with the upper and lower thrust members 150 and 130.

That is, the sleeve 170 may have the upper inclined part 172 formed on an upper end portion of the outer peripheral surface thereof so as to form a liquid-vapor interface together with the upper thrust member 150. Further, the lubricating fluid filling the bearing clearance may form the interface with the air in a space formed between the extension wall part 154 of the upper thrust member 150 and the upper inclined part 172 by a capillary phenomenon.

In addition, the sleeve 170 may have the lower inclined part 173 formed on a lower end portion of the outer peripheral surface thereof so as to form a liquid-vapor interface together with the lower thrust member 130. Further, the lubricating fluid filling the bearing clearance may form the interface with the air in a space formed between the extension part 136 of the lower thrust member 130 and the lower inclined part 173 by a capillary phenomenon.

Further, the sleeve 170 may include a radial dynamic pressure groove (not shown) formed in an inner surface thereof in order to generate fluid dynamic pressure during rotation. The radial dynamic pressure groove may have a herringbone shape or a spiral shape and include upper and lower radial dynamic pressure grooves.

Further, a thrust dynamic pressure groove (not shown) may be formed in at least one of a lower surface of the sleeve 170 and a surface of the lower thrust member 130 opposed to the lower surface of the sleeve 170 and/or at least one of an upper surface of the sleeve 170 and a surface of the upper thrust member 150 opposed to the upper surface of the sleeve 170. The thrust dynamic pressure groove may also have a herringbone shape or a spiral shape.

The rotor hub 180 may be extended from the sleeve 170. In addition, the rotor hub 180 may include a body 182 having a disk shape, a magnet mounting part 184 extended from an edge of the body 182 in the downward axial direction, and a disk support part 186 extended from the magnet mounting part 184 in an outer radial direction.

Meanwhile, the magnet mounting part 184 may include the driving magnet 184a installed on an inner surface thereof. The driving magnet 184a may be installed on the magnet mounting part 184 so as to be disposed to face a front end of the stator core 102.

Here, rotational driving of the rotor 160 will be schematically described. When power is supplied to a coil 104 wound around the stator core 102, the driving magnet 184a and the stator core 102 having the coil 104 wound therearound may electromagnetically interact with each other to generate driving force capable of rotating the rotor 160.

To this end, the driving magnet 184a may be a permanent magnet in which N and S poles are alternately magnetized in the circumferential direction.

Meanwhile, the driving magnet 184a may be installed on the magnet mounting part 184 so that a magnetic center P1 thereof in the axial direction is disposed to be higher than a magnetic center P2 of the stator core 102 in the axial direction in order to generate force directed in the downward axial direction through interaction with the stator core 102.

Therefore, a pulling plate for suppressing excessive floating of the rotor 160 may not be installed on the base member 120.

In addition, since the driving magnet 184a is installed on the magnet mounting part 184 so that the magnetic center P1 thereof in the axial direction is disposed to be higher than that P2 of the stator core 102 in the axial direction, a predetermined space may be formed in a lower edge portion of the magnet mounting part 184.

Meanwhile, the magnet mounting part 184 may include a vortex generation suppressing part 190 disposed on the lower edge portion thereof so as to decrease at least one of noise and vibrations generated by a flow of air during rotation of the rotor hub 180.

In addition, the vortex generation suppressing part 190 may be formed of a vortex generation suppressing member installed on the lower edge portion of the magnet mounting part 184 so as to be disposed below the driving magnet 184a, and the vortex generation suppressing member may have a ring shape.

Further, the vortex generation suppressing member may have the same radial length as that of the driving magnet 184a and have a rectangular transversal cross section. Further, the vortex generation suppressing member may be formed of a non-magnetic material. Therefore, loss of magnetic force generated from the driving magnet 184a may be decreased.

Meanwhile, a lower surface of the disk support part 186 may be formed as an inclined surface 186a inclined upwardly in the outer radial direction, and the surface 124 of the base member 120 opposed to the inclined surface 186a of the disk support part 186 may be disposed in parallel to the inclined surface 186a.

In addition, a clearance formed between the vortex generation suppressing part 190 formed of the vortex generation suppressing member and the base member 120 and a clearance formed between the inclined surface 186a and the opposing surface 124 may have the same width (that is, a gap having the same distance).

That is, the clearance formed between the vortex generation suppressing part 190 formed of the vortex generation suppressing member and the base member 120 and the clearance formed between the inclined surface 186a and the opposing surface 124 may have the same width (that is, the gap having the same distance) due to the vortex generation suppressing member installed on the magnet mounting part 184.

Therefore, generation of a vortex due to air flowing through the inclined surface 186a and the opposing surface 124 during the rotation of the rotor hub 180 may be decreased.

A detailed description thereof will be described below. In the case in which the vortex generation suppressing part 190 is not provided on the lower edge portion of the magnet mounting part 184, the clearance formed between the inclined surface 186a and the opposing surface 124 and a clearance formed between the lower surface of the driving magnet 184a and the upper surface of the base member 120 may have a step therebetween. That is, the clearance may be rapidly widened at a connection portion between the clearance formed by the lower surface of the driving magnet 184a and the upper surface of the base member 120 and the clearance formed by the inclined surface 186a and the opposing surface 124.

In this case, a speed of the flowing air and pressure formed by the flowing air may be rapidly changed. Therefore, a vortex is generated by the flowing air, such that vibrations and/or noise may be generated during the rotation of the rotor hub 180.

However, since the vortex generation suppressing part 190 formed of the vortex generation suppressing member is installed on the magnet mounting part 184 as described above, the clearance formed between the inclined surface 186a and the opposing surface 124 and the clearance formed between the lower surface of the vortex generation suppressing part 190 and the upper surface of the base member 120 may not have a step therebetween. Therefore, the generation of the vortex may be decreased. Further, vibrations and/or noise generated during the rotation of the rotor hub 180 may be decreased.

Hereinafter, a spindle motor according to another embodiment of the present invention will be described with reference to the accompanying drawings. However, the same components as the above-mentioned components will be denoted by the same reference numerals and a detailed description thereof will be omitted.

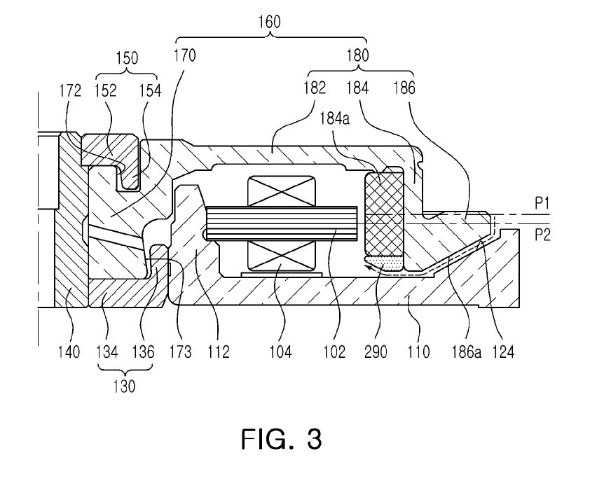

FIG. 3 is an enlarged view showing a portion of a spindle motor corresponding to part A of FIG. 1 according to another embodiment of the present invention.

Meanwhile, a spindle motor 200 according to another embodiment of the present invention is different from the spindle motor 100 according to the embodiment of the present invention in terms of a vortex generation suppressing part 290. Therefore, hereinafter, only the vortex generation suppressing part 290 will be described.

Referring to FIG. 3, the vortex generation suppressing part 290 may be formed of a non-magnetic material and be formed of a vortex generation suppressing member installed so as to decrease at least one of noise and vibrations generated by a flow of air during the rotation of the rotor hub 180.

Meanwhile, the vortex generation suppressing member may have an upper surface wider than a lower surface in the radial direction, such that it has a trapezoidal transversal cross section.

In addition, both distal ends of an inclined surface of the vortex generation suppressing member may be rounded. Therefore, the generation of the vortex due to the flowing air may be further decreased.

As described above, since the vortex generation suppressing part 290 is installed on the magnet mounting part 184, the generation of the noise and/or the vibrations may be decreased.

Hereinafter, a spindle motor according to another embodiment of the present invention will be described with reference to the accompanying drawings. However, the same components as the components of the spindle motor according to the embodiment of the present invention described above will be denoted by the same reference numerals and a detailed description thereof will be omitted.

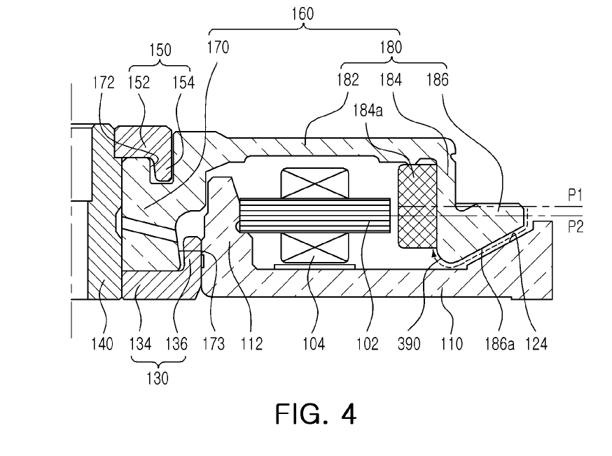

FIG. 4 is an enlarged view showing a portion of a spindle motor corresponding to part A of FIG. 1 according to another embodiment of the present invention.

Meanwhile, a spindle motor 300 according to another embodiment of the present invention is different from the spindle motor 100 according to the embodiment of the present invention in terms of a vortex generation suppressing part 390. Therefore, hereinafter, only the vortex generation suppressing part 390 will be described.

Referring to FIG. 4, the vortex generation suppressing part 390 may be formed as a rounded surface forming a lower edge portion of an inner surface of the magnet mounting part 184. Therefore, the clearance formed between the inclined surface 186a and the opposing surface 124 and the clearance formed between the lower surface of the driving magnet 184a and the upper surface of the base member 120 may not have a step therebetween. That is, a width of the clearance is gradually increased by the vortex generation suppressing part 390 formed as the rounded surface, such that the generation of the vertex may be decreased. Further, vibrations and/or noise generated during the rotation of the rotor hub 180 may be decreased.

Hereinafter, a spindle motor according to another embodiment of the present invention will be described with reference to the accompanying drawings.

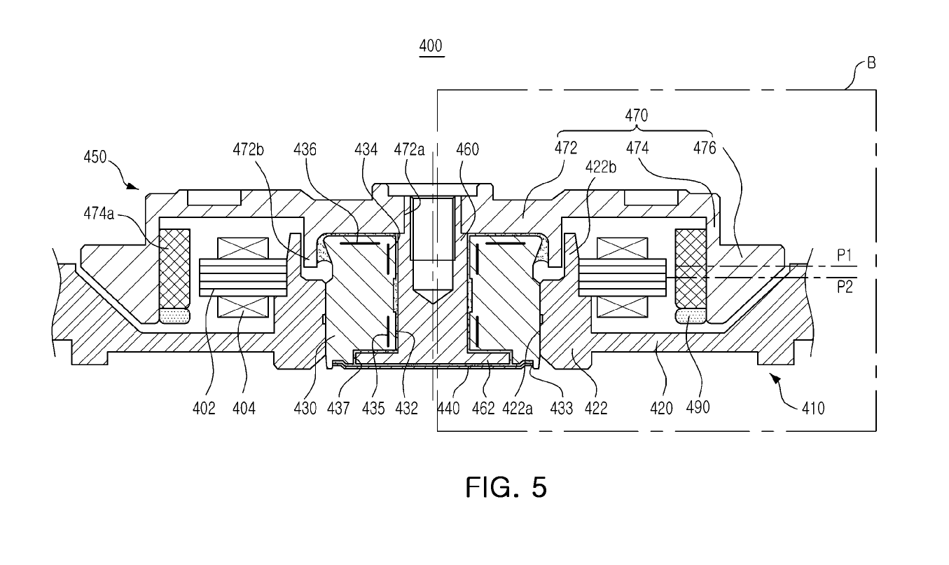

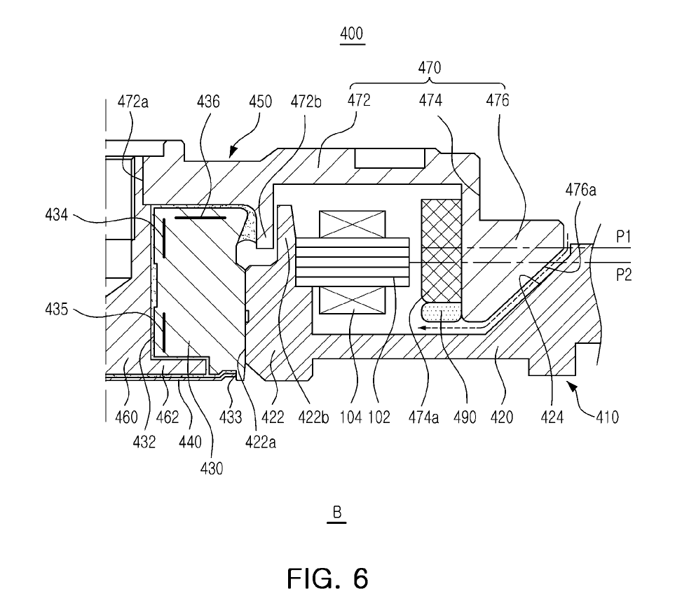

FIG. 5 is a cross-sectional view schematically showing a spindle motor according to another embodiment of the present invention; and FIG. 6 is an enlarged view showing part B of FIG. 5.

Referring to FIGS. 5 and 6, a spindle motor 400 according to another embodiment of the present invention may include a stator 410 and a rotor 450 by way of example.

Meanwhile the stator 410, referring to all fixed members except for a rotating member, may include a base member 420, a sleeve 430, and the like.

In addition, the rotor 450, referring to a member rotating together with a shaft 460, may include the shaft 460 and a rotor hub 470.

The base member 420 may include an installation part 422 into which the sleeve 430 is inserted. The installation part 422 may protrude in an upward axial direction and include an installation hole 422a formed therein so that the sleeve 430 may be inserted thereinto.

Meanwhile, the installation part 422 may include a protrusion wall body 422b for forming a labyrinth seal together with the rotor hub 470. In addition, the protrusion wall body 422b may include a stator core 402 installed on an outer peripheral surface thereof, and the stator core 402 has a coil 404 wound therearound. The stator core 402 may be fixedly installed on the outer peripheral surface of the protrusion wall body 422b by an adhesion or press-fitting method.

In addition, the base member 420 may be manufactured by performing die-casting using an aluminum (Al) material. Alternatively, the base member 420 may be molded by performing plastic working (for example, press working) on a steel plate.

That is, the base member 420 may be manufactured by various materials and various processing methods, and is not limited to the base member 420 shown in FIGS. 5 and 6.

The sleeve 430, a fixed member configuring, together with the base member 420, the stator 410, may be fixedly installed on the base member 420.

That is, the sleeve 430 may be inserted into and fixed to the above-mentioned installation part 422. In other words, a lower end portion of an outer peripheral surface of the sleeve 430 may be bonded to an inner peripheral surface of the installation part 422 by at least one of an adhesion method, a welding method, and a press-fitting method.

Further, the sleeve 430 may include a shaft hole 432 formed therein, and the shaft hole 432 has the shaft 460 inserted thereinto. The shaft 460 may be inserted into the shaft hole 432 and be rotatably supported by the sleeve 430.

In addition, the sleeve 430 may include a mounting groove 433 formed in a lower end portion thereof, wherein the mounting groove 433 has a cover member 440 installed therein in order to prevent leakage of a lubricating fluid. Further, during installing the cover member 440, a bearing clearance filled with the lubricating fluid may be formed by an upper surface of the cover member 440 and a lower surface of the shaft 460.

Hereinafter, the bearing clearance will be described.

The bearing clearance indicates a clearance filled with the lubricating fluid. That is, a clearance formed between an inner surface of the sleeve 430 and an outer surface of the shaft 460, a clearance formed between the sleeve 430 and the rotor hub 470, and a clearance formed between the cover member 440 and the shaft 460 are all defined as the bearing clearance.

In addition, the spindle motor 400 according to the present embodiment may have a structure in which all of the above-mentioned bearing clearances are filled with the lubricating fluid. This structure may also be called a full-fill structure.

In addition, the sleeve 430 may include upper and lower radial dynamic pressure grooves 434 and 435 formed in an inner peripheral surface thereof in order to generate fluid dynamic pressure during rotational driving of the shaft 460. In addition, the upper and lower radial dynamic pressure grooves 434 and 435 may be disposed to be spaced apart from each other by a predetermined interval and have a herringbone or spiral shape.

However, the upper and low radial dynamic pressure grooves 434 and 435 are not limited to being formed in the inner peripheral surface of the sleeve 430, but may also be formed in the outer peripheral surface of the shaft 460.

Further, an upper end portion of the outer peripheral surface of the sleeve 430 may be inclined so as to form a liquid-vapor interface together with the rotor hub 470.

That is, the upper end portion of the outer peripheral surface of the sleeve 430 may be inclined in order to form the liquid-vapor interface between the lubricating fluid and the air by a capillary phenomenon.

Meanwhile, a thrust dynamic pressure groove 436 may be formed in an upper surface of the sleeve 430. In addition, the thrust dynamic pressure groove 436 may also be formed in a lower surface of the rotor hub 470 opposed to the upper surface of the sleeve 430. That is, the thrust dynamic pressure groove 436 may be formed in at least one of the upper surface of the sleeve 430 and the lower surface of the rotor hub 470 opposed to the upper surface of the sleeve 430.

However, the thrust dynamic pressure groove 436 is not limited to being formed in at least one of the upper surface of the sleeve 430 and the lower surface of the rotor hub 470 opposed to the upper surface of the sleeve 430, but may also be formed in at least one of the lower surface of the shaft 460 and the upper surface of the cover member 440.

The thrust dynamic pressure groove may generate dynamic pressure floating the rotor hub 470 at a predetermined height during rotation of the rotor hub 470, and the liquid-vapor interface may move toward the bearing clearance by the floating of the rotor hub 470.

The shaft 460, a rotating member configuring the rotor 450, may be inserted into the sleeve 430 and rotate. That is, the shaft 460 may be rotatably supported by the sleeve 430. In addition, the shaft 460 may include a flange part 462 formed on a lower end portion thereof, and the flange part 462 is inserted into a step groove 437.

The flange part 462 may be extended from the lower end portion of the shaft 460 in the outer radial direction and serve to prevent excessive floating of the shaft 460 while preventing the shaft 460 from being separated upwardly from the sleeve 430.

That is, the flange part 462 may prevent the shaft 460 from being separated upwardly from the sleeve 430 due to an external impact. In addition, the shaft 460 may be floated at a predetermined height during the rotational driving thereof. At this time, the flange part 462 may prevent the shaft 460 from being excessively floated.

Further, the shaft 460 may have the rotor hub 470 coupled to an upper end portion thereof. To this end, in the case in which the shaft 460 is installed in the sleeve 430, the upper end portion of the shaft 460 may be disposed to protrude upwardly of the sleeve 430.

The rotor hub 470, a rotating member configuring the rotor 450 together with the shaft 460, may be fixedly installed on the upper end portion of the shaft 460 and rotate together with the shaft 460.

Meanwhile, the rotor hub 470 may include a body 472 provided with a mounting hole 472a into which the upper end portion the shaft 460 is inserted, a magnet mounting part 474 extended from an edge of the body 472 in the downward axial direction, and a disk support part 476 extended from a distal end of the magnet mounting part 474 in the outer radial direction.

In addition, the magnet mounting part 474 may have a driving magnet 474a installed on an inner surface thereof, and the driving magnet 474a is disposed to face a front end of the stator core 402 having the coil 404 wound therearound.

Meanwhile, the driving magnet 474a may have an annular ring shape and be a permanent magnet generating magnetic force having a predetermined strength by alternately magnetizing N and S poles in the circumferential direction.

Meanwhile, the body 472 may be provided with an extension wall body 472b extended in the downward axial direction so as to form an interface between the lubricating fluid and air, that is, a liquid-vapor interface together with the outer peripheral surface of the sleeve 430.

An inner surface of the extension wall body 472b may be disposed to face the upper end portion of the outer peripheral surface of the sleeve 430.

Meanwhile, the driving magnet 474a may be installed on the magnet mounting part 474 so that the magnetic center P1 thereof in the axial direction is disposed to be higher than that P2 of the stator core 402 in the axial direction in order to generate force directed in the downward axial direction through interaction with the stator core 402.

Therefore, a pulling plate for suppressing excessive floating of the rotor 450 may not be installed on the base member 420.

In addition, since the driving magnet 474a is installed on the magnet mounting part 474 so that the magnetic center P1 thereof in the axial direction is disposed to be higher than that P2 of the stator core 402 in the axial direction, a predetermined space may be formed in a lower edge portion of the magnet mounting part 474.

Meanwhile, the magnet mounting part 474 may include a vortex generation suppressing part 490 disposed on a lower edge portion thereof so as to decrease at least one of noise and vibrations generated by a flow of air during rotation of the rotor hub 470.

In addition, the vortex generation suppressing part 490 may be formed of a vortex generation suppressing member installed on the lower edge portion of the magnet mounting part 474 so as to be disposed below the driving magnet 474a, wherein the vortex generation suppressing member may have a ring shape.

Further, the vortex generation suppressing member may have the same width as that of the driving magnet 474a in the radial direction and have a rectangular transversal cross section. Further, the vortex generation suppressing member may be formed of a non-magnetic material. Therefore, loss of magnetic force generated from the driving magnet 474a may be decreased.

Meanwhile, a lower surface 476 of the disk support part 476 may be formed as an inclined surface 476a inclined upwardly in the outer radial direction, and a surface 424 of the base member 420 opposed to the inclined surface 476a of the disk support part 476 may be disposed in parallel to the inclined surface 476a.

In addition, a clearance formed between the vortex generation suppressing part 490 formed of the vortex generation suppressing member and the base member 420 and a clearance formed between the inclined surface 476a and the opposing surface 424 may have the same width (that is, a gap having the same distance).

That is, the clearance formed between the vortex generation suppressing part 490 formed of the vortex generation suppressing member and the base member 420 and the clearance formed between the inclined surface 476a and the opposing surface 424 may have the same width (that is, the gap having the same distance) due to the vortex generation suppressing member installed on the magnet mounting part 474.

Therefore, generation of a vortex due to air flowing through the inclined surface 476a and the opposing surface 424 during the rotation of the rotor hub 470 may be decreased.

A detailed description thereof will be provided below. In the case in which the vortex generation suppressing part 490 is not provided on the lower edge portion of the magnet mounting part 474, the clearance formed between the inclined surface 476a and the opposing surface 424 and the clearance formed between the lower surface of the driving magnet 474a and the upper surface of the base member 420 may have a step therebetween. That is, the clearance may be rapidly widened at a connection portion between the clearance formed by the lower surface of the driving magnet 474a and the upper surface of the base member 420 and the clearance formed by the inclined surface 476a and the opposing surface 424.

In this case, a speed of the flowing air and pressure formed by the flowing air may be rapidly changed. Therefore, a vortex is generated by the flowing air, such that the vibrations and/or the noise may be generated during the rotation of the rotor hub 470.

However, since the vortex generation suppressing part 490 formed of the vortex generation suppressing member is installed on the magnet mounting part 474 as described above, the clearance formed between the inclined surface 476a and the opposing surface 424 and the clearance formed between the lower surface of the vortex generation suppressing part 490 and the upper surface of the base member 420 may not have a step therebetween. Therefore, the generation of the vortex may be decreased. Further, the vibrations and/or the noise generated during the rotation of the rotor hub 470 may be decreased.

Meanwhile, hereinabove, although the case in which the vortex generation suppressing part 490 is the same as the vortex generation suppressing part 190 provided in the spindle motor 100 according to the embodiment of the present invention has been described by way of example, the vortex generation suppressing part 490 may be configured to be the same as the vortex generation suppressing part 290 provided in the spindle motor 200 according to another embodiment of the present invention or as the vortex generation suppressing part 390 provided in the spindle motor 300 according to another embodiment of the present invention.

As set forth above, according to embodiments of the present invention, the generation of a vortex during rotation of a rotor hub is decreased through a vortex generation suppressing part, whereby the generation of noise and/or vibrations may be decreased.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a stator including a base member on which a stator core is fixedly installed; and
a rotor including a rotor hub in which a driving magnet disposed to face the stator core is installed,
wherein the rotor hub includes a body having a disk shape, a magnet mounting part extended from an edge of the body in a downward axial direction and having the driving magnet installed on an inner surface thereof, and a disk support part extended from the magnet mounting part in an outer radial direction,
the driving magnet is installed on the magnet mounting part so that a magnetic center thereof is disposed to be higher than that of the stator core in the axial direction in order to generate force directed in the downward axial direction through interaction with the stator core, and
the magnet mounting part includes a vortex generation suppressing part disposed on a lower edge portion thereof so as to decrease at least one of noise and vibrations generated by a flow of air during rotation of the rotor hub.

2. The spindle motor of claim 1, wherein the vortex generation suppressing part is formed of a vortex generation suppressing member installed on the lower edge portion of the magnet mounting part so as to be disposed below the driving magnet, the vortex generation suppressing member having a ring shape.

3. The spindle motor of claim 2, wherein the vortex generation suppressing member has the same width as that of the driving magnet in the radial direction and has a rectangular transversal cross section.

4. The spindle motor of claim 2, wherein the vortex generation suppressing member has an upper surface wider than a lower surface in the radial direction, such that it has a trapezoidal transversal cross section.

5. The spindle motor of claim 2, wherein the vortex generation suppressing member is formed of a non-magnetic material.

6. The spindle motor of claim 2, wherein a lower surface of the disk support part is formed as an inclined surface inclined upwardly in the outer radial direction,
an opposing surface of the base member opposed to the inclined surface of the disk support part is disposed in parallel to the inclined surface, and
a clearance formed between the vortex generation suppressing member and the base member and a clearance formed between the inclined surface and the opposing surface have the same width.

7. The spindle motor of claim 1, wherein a lower surface of the disk support part is formed as an inclined surface inclined upwardly in the outer radial direction,
an opposing surface of the base member opposed to the inclined surface of the disk support part is disposed in parallel to the inclined surface, and
the vortex generation suppressing part is formed as a rounded surface forming a lower edge portion of an inner surface of the magnet mounting part.

8. The spindle motor of claim 1, wherein the stator includes:
the base member including an installation part on which the stator core is installed;
a lower thrust member fixedly installed on an inner surface of the installation part;
a shaft having a lower end portion fixedly installed on the lower thrust member; and
an upper thrust member fixedly installed on an upper end portion of the shaft.

9. The spindle motor of claim 8, wherein the rotor includes a sleeve forming, together with the lower thrust member, the shaft, and the upper thrust member, bearing clearances, and the rotor hub extended from the sleeve.

10. A spindle motor comprising:
a base member having a stator core fixedly installed thereon;
a sleeve fixedly installed on the base member;
a shaft inserted into the sleeve and rotating; and
a rotor hub fixedly installed on the shaft and including a body having a disk shape, a magnet mounting part extended from an edge of the body in a downward axial direction and having a driving magnet installed on an inner surface thereof, and a disk support part extended from the magnet mounting part in an outer radial direction,
wherein the driving magnet is installed on the magnet mounting part so that a magnetic center thereof is disposed to be higher than that of the stator core in the axial direction in order to generate force directed in the downward axial direction through interaction with the stator core, and
the magnet mounting part includes a vortex generation suppressing part disposed on a lower edge portion thereof so as to decrease at least one of noise and vibrations generated by a flow of air during rotation of the rotor hub.
